(19) United States
(12) Patent Application Publication
(10) Pub. No.: US 2002/0071962 A1
(43) Pub. Date: Jun. 13, 2002

(54) Nanolaminate mechanical structures

(76) Inventors: Chris M. Schreiber, Lake Elsinore, CA (US); Mordechay Schlesinger, Pittsburgh, PA (US); Eric Dean Jensen, Irvine, CA (US); Haim Feigenbaum, Irvine, CA (US); William Robert Crumly, Anaheim, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/733,463

(22) Filed: Dec. 8, 2000

(51) Int. Cl. B32B 15/20

(52) U.S. Cl. 428/635; 428/675

(57) ABSTRACT

A nanolaminate structure comprises a plurality of adjacent metal layers with each layer having a thickness of less than about 1000 nanometers. The composition of the adjacent metal layers alternates between a first metal and a second metal, where at least one mechanical property of the nanolaminate is improved over the same mechanical property of the first and second metal.

### FIELD OF THE INVENTION

The present invention relates to nanolaminate mechanical structures having desired mechanical properties, comprising a plurality of metallic nanolayers.

### BACKGROUND OF THE INVENTION

In many fields today, devices are being created from very small components. For example, in the electronics field, the size of integrated circuits and other electronic components is constantly being reduced. To support and interconnect these and other components, as well as to provide small-scale structural components, there is growing need for structural components with desired mechanical characteristics, such as modulus of elasticity, elongation, and/or yield strength, with the required mechanical characteristic dependent on the particular application.

Given the relatively small size of many of today's electronic components, maintaining reliable electrical contact between components, such as between an integrated circuit and a printed circuit board, has become very difficult. A component providing such connection must be a conductive material, as well as provide a minimum force to maintain the electrical contact. One solution for providing reliable electrical contact between a circuit board and another component is to use an interposer comprising a plurality of very small metal springs, i.e., microsprings. However, the mechanical properties of individual metals may be inadequate to properly form such microsprings. For example, copper may prove too soft, while nickel may prove too brittle. It has been found that by fabricating such microsprings from a combination of layers of metals, rather than from a single metal, the spring properties of the resulting composition are improved. Such an interposer device comprising microsprings formed from multiple layers of metals is disclosed in commonly assigned U.S. patent application Ser. No. 09/454,804, filed Dec. 3, 1999, entitled “Metallic Microstructure Spring.”

In view of the foregoing, it is desirable to provide structure which have improved mechanical properties over conventional metals.

### SUMMARY OF THE INVENTION

The present invention comprises a nanolaminate structure, comprising at least one layer of substantially a first metal, having an individual layer thickness of 1000 nanometers or less, adjacent at least one layer of substantially a second metal, having an individual layer thickness of 1000 nanometers or less. The nanolaminate structure has at least one mechanical property with a desired value, which is significantly improved over the same mechanical property of the first or second metal.

In one embodiment, the above described structure is repeated so that a plurality of layers are formed, alternating between substantially the first metal and substantially the second metal, until the nanolaminate reaches the desired thickness, and has the desired mechanical properties.

### BRIEF DESCRIPTION OF THE DRAWINGS

The features, aspects and advantages of the present invention will be more fully understood when considered with respect to the following detailed description, appended claims and accompanying drawings, wherein:

FIG. 1 is a semi-schematic cross-sectional side view of a mandrel having out-of-plane features, wherein the mandrel is being used to form a nanolaminate structure having corresponding, i.e., mirror image, out-of-plane features;

FIG. 2 is a semi-schematic cross-sectional side view of a nanolaminate structure such as that formed utilizing the mandrel of FIG. 1;

FIG. 3 is a flow chart showing the process of forming a nanolaminate structure according to the present invention;

FIG. 4 is a semi-schematic perspective view of a nanolaminate interposer containing according to the present invention;

FIG. 5 is an enlarged semi-schematic top view of a portion of the interposer of FIG. 4; and

FIG. 6 is an enlarge semi-schematic perspective view of two nanolaminate structure microsprings according to the present invention.

### DETAILED DESCRIPTION

The detailed description set forth below in connection with the appended drawings is intended as a description of the presently preferred embodiments of the invention, and is not intended to represent the only form in which the present invention may be constructed or utilized. The description sets forth the construction and functions of the invention, as well as the sequence of steps for operating the invention in connection with the illustrated embodiment. It is to be understood, however, that the same or equivalent functions may be accomplished by different embodiments that are also intended to be encompassed within the spirit and scope of the invention.

The present invention comprises nanolaminate structures having desired mechanical properties. Nanolaminates may comprise up to 1000, 5000, or even 10,000 or more metallic nanolayers, with each layer being less than approximately 1000 nanometers, i.e., less than 1 micron, in thickness. By controlling the thickness of the individual metal layers, the mechanical and electrical characteristics of the resulting nanolaminate may be controlled. In one embodiment, such nanolayers are preferably formed by plating metals onto a substrate, but it will be appreciated that such nanolayers may also be formed sputtering, or any other method known to those skilled in the art.

The substrate, which in one embodiment is a mandrel, is the cathode, and is plated according to a predefined pattern. It will be appreciated by those skilled in the art that this substrate can include any conductive surface, such as metals, films, metallized plastics or any other conductive surface known in the art. It will be further appreciated that “mandrel” is used in the broadest sense of the word, as known to those skilled in the art, to include such other conductive surfaces. In a particular embodiment, the mandrel is a stainless steel plate, approximately 1/16 inch thick. By using a mandrel, and plating the layers of metal(s) onto the mandrel, a variety of shapes of nanolaminates may be formed. By forming indentations or protrusions on the mandrel, corresponding structures are formed on the nanolaminate. By use of etching, laser ablation, or other techniques, portions of the layer may be removed, so that the resulting nanolaminate structure may be in a variety of forms, such as a spring. It will be appreciated by those skilled in the art that such nanolaminate structures may also be formed by masking or otherwise depositing a conductive pattern on the mandrel, thereby plating only the desired pattern. It will be further appreciated that the pattern to be plated may also be defined by using photoresist and developing the same to create a pattern for plating, or any other technique known in the art for creating electrically conductive patterns or shapes.

The yield strength, hardness, modulus of elasticity, elongation and other properties of the resulting nanolaminate structure may all be controlled by controlling the thickness of the metal layers. Thus nanolaminate structures are extremely well suited to such microscopic applications as forming conductive spring structures in an interposer. By using nanolaminates, and controlling the thickness of the metal layers, microscopic structures may be created having desired mechanical properties, such as springs having the desired size, force and elasticity characteristics. Depending on the application, particular electrical or magnetic characteristics may also be desired, which may also be produced by controlling the layer thickness within the nanolaminate. It will be appreciated by those skilled in the art that the nanolaminate structures of the present invention may be used in a wide variety of applications in addition to microsprings, such as, for example, using nanolaminate structures as coatings on another structure to control corrosion, wear, friction, electrical or magnetic properties.

Such nanolaminates may be formed by any method, but preferably are formed by plating a substrate with a plurality of alternating layers of a first metal and a second metal. The substrate is plated using an electrolytic plating process and controlling at least one parameter of the process, preferably the current, in a manner which provides control of the thickness of the metal layers so as to similarly provide control of at least one mechanical property of the resulting nanolaminate structure. In this manner, a nanolaminate structure having at least one mechanical property with approximately a desired value is provided.

A bath containing ions of two metals is provided and a substrate is placed at least partially within the bath, so as to effect plating of the substrate with metal from the bath. The two metals preferably comprise a more noble metal and a less noble metal, such as copper and nickel, respectively. A parameter of the plating process, preferably plating current, is controlled in a manner which results in control of which of the two metals is being plated at a particular time. For example, the plating current may be controlled in a manner which results in a layer of the more noble metal being deposited, while substantially none of the less noble metal is deposited, and then the plating current may be adjusted in a manner in which results in a layer of an alloy of both the more noble metal and the less noble metal being deposited. This process may be repeated so as to facilitate the formation of a plurality of alternating layers of substantially 1) the more noble metal, and 2) the alloy of both metals.

While the previously described plating process is the preferred method of producing such nanolaminate, it will be appreciated by those skilled in the art that any method of producing such metallic layers and laminating then to form a nanolaminate may be used. In a preferred embodiment, alternating nanolayers of copper and a nickel-copper alloy are deposited. By controlling the thickness of the layers between approximately 0.5 and 1000 nanometers, preferably between 0.8 and 200 nanometers, more preferably between 3 and 150 nanometers, a dramatic improvement in the mechanical properties of the nanolaminate, as compared to the mechanical properties of either of the individual constituent metals, is achieved. It has been discovered that by maintaining the layer thickness below approximately 1000 nanometers, the mechanical properties of the nanolaminate are greatly improved over the mechanical properties of the individual constituent metals.

In one embodiment, there is an optimum nickel thickness of 4 nanometers. Preferably the copper thickness is from about 0.8 to less than about 100 nanometers. The elastic properties depend upon the copper thickness, where the nickel thickness can be between 0.8 to 100 nanometers. At layer thicknesses greater than 1000 nanometers, the layers behave as bulk materials.

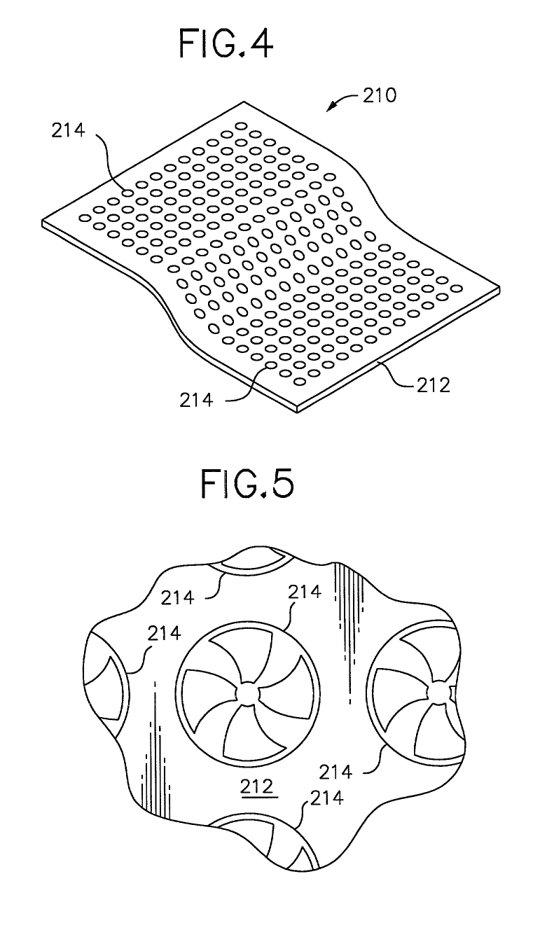

For example, while the yield strength of copper is approximately 6,000 psi, and the yield strength of nickel is approximately 30,000 psi, and the yield strength of a 99% nickel-1% copper alloy is approximately 29,700 psi, the yield strength of a nanolaminate according to the present invention may be improved by greater than a factor of 10, with the yield strength of the nanolaminate approaching 400,000 psi. In another embodiment for an interposer of metallic microsprings, as shown in FIGS. 4 and 5, the thicknesses of the respective metallic nanolayers are controlled so as to affect certain mechanical properties and maximize the ratio of yield strength to modulus of elasticity of the nanolaminate, in order to produce microsprings having optimum mechanical properties.

For example, in one particular embodiment of the present invention, a bath of nickel and copper ions in the concentration of 15.2 oz. nickel ions/gal. solution: 0.117 oz. copper ions/gal solution were used. The copper was provided by copper sulfate, while the nickel was provided by nickel sulfamate. The bath also contained sodium dodecyl sulfate. A 316 S/S mandrel, 0.060 inch thick was used, having a surface area of 25 in². The mandrel was placed in the bath at a current of 0.260 amps. The current was kept at this setting for approximately 16.8 seconds, plating a layer of copper approximately 20 nanometers thick. The current was then changed to 2.60 amps for approximately 3.59 seconds. This resulted in plating of a layer of nickel-copper alloy approximately 20 nanometers thick. This process was repeated until 635 total alternating layers were formed into a nanolaminate structure. During the plating procedure, the concentration of the electrolytic plating bath was maintained by adding 2.21 ml of a copper sulfate solution comprising 10 oz. of copper metal per gallon and 0.91 ml of a nickel sulfamate solution comprising 24 oz. of nickel metal per gallon at intervals of 20.05 minutes.

In addition, other nanolaminate structures were formed with the following typical properties: For a nanolaminate having approximately 100 alternating layers of copper and a nickel-copper alloy containing less than 1% copper, with the copper layer thickness approximately 1 nanometer and the nickel-copper alloy layer thickness approximately 8 nanometers, a hardness of approximately 4.5 gigapascals (GPa) was achieved. For a nanolaminate having approximately 100 alternating layers of copper and a nickel-copper alloy containing less than 1% copper, with the copper layer thickness approximately 2.5 nanometer and the nickel-copper alloy layer thickness approximately 4 nanometers, a modulus of elasticity of approximately 110 GPa was achieved. It will be appreciated by those skilled in the art that such values are typical, and illustrate how specific properties may be manipulated, and that a wide range of values may be obtained through variations in layer thickness and number of layers.

It has been discovered that by limiting the layer thickness of the individual nanolayers to less than approximately 1000 nanometers, i.e., 1 micron, the occurrence of dislocations, or voids in the crystalline structure, can be reduced, resulting in greatly improved mechanical properties. By keeping the layers of the nanolaminate at such a nanothickness, the area in which such dislocations or irregularities is greatly reduced, thereby constraining the materials into a more uniform structure on an atomic level, by reducing the number of atoms which may be “out of place” in a particular row, layer or lattice.

In a preferred method of forming the nanolaminate, the nanolayers are deposited onto an electrically conductive substrate, preferably a mandrel. As discussed previously, and as will be appreciated by those skilled in the art, the configuration of the substrate, or mandrel, including thickness, surface area, and composition, will vary depending on the application. In one embodiment, the mandrel is approximately 1/16 (0.060) inch thick stainless steel, with a plating surface area of 25 in². It will be appreciated by those skilled in the art that the mandrel may take a variety of forms, as long as it provides an adequate conductive plating surface for the particular application. In another embodiment, a two-sided mandrel is used, comprising parallel sheets of stainless steel less than 1/16 inch thick, bonded to a central core.

Recessed or protruding dimensional features, called out-of-plane features, may be formed in the nanolaminate structure by providing a mandrel having corresponding, i.e., mirror image, out-of-plane features formed thereon. Thus, raised features may be formed in the nanolaminate structure by providing a mandrel having complimentary depressed features formed therein. Similarly, depressed features may be formed in the nanolaminate structure by providing a mandrel having complimentary raised features formed therein. The mandrel may have both raised and depressed features formed therein, so as to effect the formation of both depressed and raised features in the nanolaminate structure. The raised and/or depressed features may be formed in the mandrel using various processes, including mechanical deformation, extrusion, machining, laser ablation or any other techniques known in the art.

The use of such a mandrel having out-of-plane features thus facilitates the formation of nanolaminate structures having corresponding out-of-plane features in a manner which is comparatively simple and inexpensive, particularly when compared with the complexity and cost associated with forming such features via contemporary photolithographic processes.

The substrate, i.e., mandrel is plated according to a predefined pattern. The pattern may be defined by providing a mask for the mandrel, such that the mandrel is only plated in desired areas, i.e., according to the predefined pattern.

According to the present invention, the thickness of the nanolaminate structure, preferably the thickness of each layer of the nanolaminate structure, is controlled so as to provide a nanolaminate structure having a modulus of elasticity with approximately a desired value. Thus, according to the present invention, mechanical properties of the nanolaminate structure may be controlled by controlling the thickness of the layers which define the nanolaminate structure. It will be appreciated by those skilled in the art that other mechanical properties, including, but not limited to yield strength, elongation, hardness, fracture toughness, and crack propagation, as well as electrical and magneto-resistive properties are also controlled by the thickness of the individual nanolayers comprising the nanolaminate.

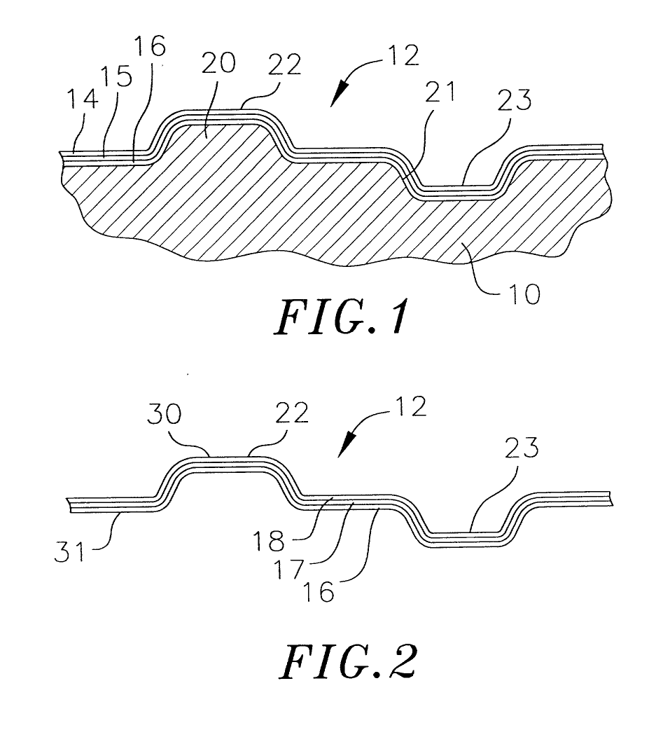

Referring now to FIG. 1, a mandrel 10 has a plurality of plated layers 14, 15, and 16, formed thereupon so as to define a nanolaminate structure 12. The nanolaminate structure has out-of-plane features, such as raised feature 22 formed by corresponding raised portion 20 of the mandrel 10 and depressed feature 23 formed by corresponding depressed portion 21 of the mandrel 10.

The nanolaminate structure 12 is formed upon the mandrel 10 utilizing an electrolytic plating process, as described in detail below.

Referring now to FIG. 2, the nanolaminate structure 22 has been removed from the mandrel 10, so as to provide a component for a mechanical system. The nanolaminate structure 12 may be attached to a substrate, via either the upper 30 or lower 31 surface thereof, as desired.

As those skilled in the art will appreciate, such a nanolaminate structure may be utilized to form various different desired structural and/or electrical components. According to the present invention, mechanical properties of the nanolaminate structure 12 are controlled, so as to facilitate the fabrication of a nanolaminate structure having such desired properties. For example, the modulus of elasticity may be controlled by varying the thickness of the layers which comprise the nanolaminate layers 14, 15 and 16, which comprise a nanolaminate structure 12. For example, the nanolaminate structure may comprise alternating layers of 1) a more noble metal, such as copper, and 2) an alloy of more noble and less noble metals, such as a nickel-copper alloy. While the illustrated nanolaminate structure is shown having only three layers for simplicity, it should be understood that nanolaminate structures having 100, 500, or up to more than 1000 layers, each having a thickness of less than 1 micron, can be provided in accordance with practice of the present invention.

The thickness of each of the individual nanolaminate layers determines the value of the desired mechanical property. For example, controlling the thickness of the nickel-copper alloy layer will more directly affect the yield strength of the nanolaminate, while controlling the thickness of the copper layer will more directly affect the modulus of elasticity of the nanolaminate. It will be appreciated by those skilled in the art that other metals may also be used to plate the plurality of layers, such as iron, cobalt, or any other metals, and that controlling the respective thicknesses may affect other mechanical properties. In addition, a plurality of nanolayers of a single metal, or more than two different metals, may also be used.

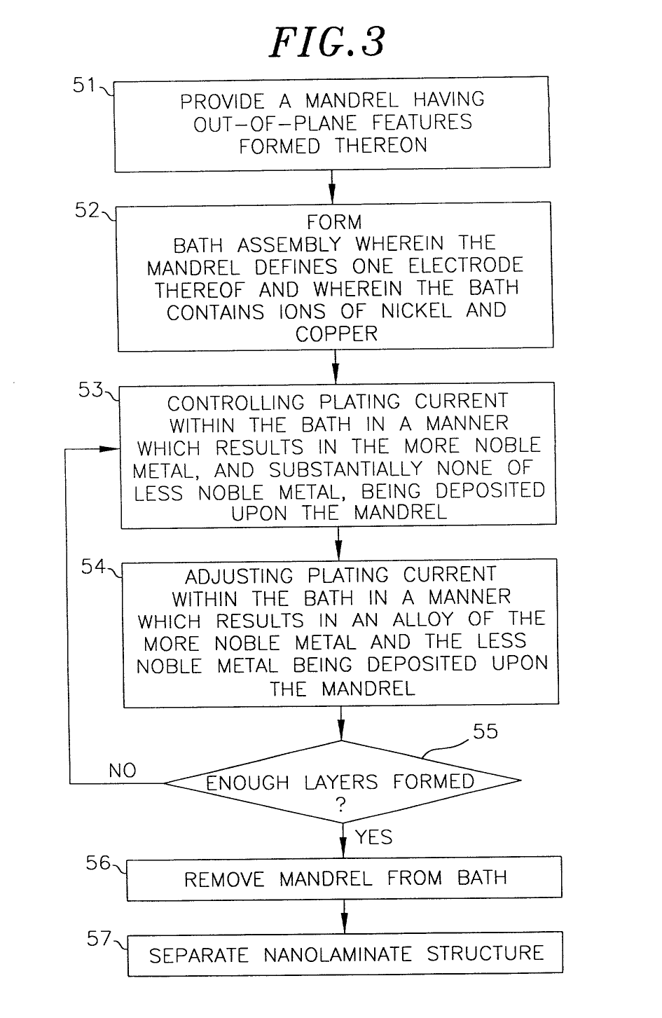

Referring now to FIG. 3, the nanolaminate structure 12 of FIGS. 1 and 2 is formed by providing a mandrel having out-of-plane features, as shown in block 51.

As shown in block 52, an electrolytic plating bath assembly is formed such that the mandrel 10 defines one electrode thereof. A bath containing ions of a first metal and a second metal is provided and the mandrel is placed at least partially within the bath, so as to effect plating of the mandrel with metal from the bath. The two metals preferably comprise a more noble metal and a less noble metal, such as copper and nickel, respectively. A parameter of the plating process, preferably plating current density, is controlled in a manner which results in control of which of the two metals is being plated at a particular time. For example, the plating current may be controlled in a manner which results in a layer of the more noble metal being deposited, and substantially none of the less noble metal being deposited, and then the plating current may be controlled in a manner which results in a layer of an alloy of the more noble metal and the less noble metal being deposited.

As shown in block 53, the plating current of the bath is controlled in a manner which results in a layer of the more noble metal, i.e., copper, being deposited on the mandrel with substantially none of the less noble metal, i.e., nickel, being deposited upon the mandrel. Then, the plating current is adjusted within the bath in a manner which results in a layer of an alloy of the more noble metal and the less noble metal being deposited upon the mandrel 10. Alternatively, the alloy may be deposited upon the mandrel before the more noble metal is deposited thereupon. It will be further appreciated by those skilled in the art that each metallic nanolayer may be formed of a single metal, such as nickel or copper, or an alloy, such as a combination of nickel and copper, and that subsequent adjacent layers may similarly be formed of a single metal, either the same or different form the adjacent layer, or an alloy, either the same or different from the adjacent layer.

It will be appreciated by those skilled in the art that the current densities at which the particular metals or alloys will plate out in a particular solution may be determined through use of a Hull Cell. While this technique is well known to those skilled in the art, additional information is set forth in the article Sanicky, Marilyn K., “A Versatile Plater's Tool: All About the Hull Cell,” Plating and Surface Finishing, October 1985, which is herein incorporated by reference. Using the Hull Cell, one may determine the critical current density below which the more noble metal plates, and at which substantially none of the less noble plates, and above which both metals will plated as an alloy comprised substantially of the less noble metal. For example, in the case of a bath containing copper and nickel ions, in a ratio of approximately 1:100 respectively, it has been discovered that 1.5 amps/ft² is the critical current density. At a current density below this, preferably a current density of approximately 1.0 amps/ft², substantially only copper will plate. However, at a current density above this, preferably a current density of approximately 2.5 to 25 amps/ft², both copper and nickel will plate, resulting in an alloy approximately 99% nickel and 1% copper. By varying the current density, and thereby changing the plating voltage, alternating layers of 1) the more noble metal, and 2) the alloy of both metals may be plated out. It will be appreciated by those skilled in the art that in addition to using a variety of metals and or alloys, the concentrations of the metal ions may also be varied, depending on the specific properties desired.

This process may be repeated so as to facilitate the formation of a plurality of alternating layers of substantially 1) the more noble metal, and 2) the alloy of both metals. The ratio of the more noble metal to the less noble metal in the alloy can be controlled by controlling the concentration of the ions of the more noble metal in the bath. In a preferred embodiment, the concentration of copper ions to nickel ions in the plating bath is 1:100, resulting in plating layers of copper, and nickel-copper alloy respectively, where the alloy is approximately 1% copper and 99% nickel. It will be appreciated by those skilled in the art that the ions in the bath may be provided by salts of the metals, such as copper sulfate, and that other metals may also be used in addition to, or in place of copper and nickel.

In either instance, the process of adjusting the current to alternately plate layers of 1) the more noble metal and 2) the alloy of both metals is continued until the desired number of such layers is formed upon the mandrel.

After the desired number of layers have been formed upon the mandrel, a backing substrate may optionally be formed upon the nanolaminate structure, preferably while the nanolaminate structure is still attached to the mandrel. However, it will be appreciated by those skilled in the art that such a substrate may also formed upon the nanolaminate structure after it is removed from the mandrel. As shown in FIG. 2, the nanolaminate structure 12 is removed from the mandrel 10, and may be processed further, as desired and/or assembled along with other components.

Referring now to FIG. 4, nanolaminate structures may be used to form an interposer 210, comprising a plurality of nanolaminate microsprings 214 coupled to a backing substrate 212. Such microsprings have dimensions on the order of height of approximately 0.1 to 0.2 mm, and diameter of approximately 0.1 to 0.5 mm. However, it will be appreciated that these dimensions are indicative only of a typical application, and that nanolaminate microsprings may be formed having a wide variety of dimensions. Preferably, such a backing substrate is formed from a polyimide or polymer film. One example of such a film is KAPTON (a registered trademark of E.I. du Pont de Nemours and Company of Circleville, Ohio). It will be appreciated by those skilled in the art that in such an application, the microsprings 214 may be electrically insulated from one another.

Referring now to FIG. 5, as described above, the nanolaminate structures, through etching, masking or other techniques, may be defined to form individual components, such as microsprings 214.

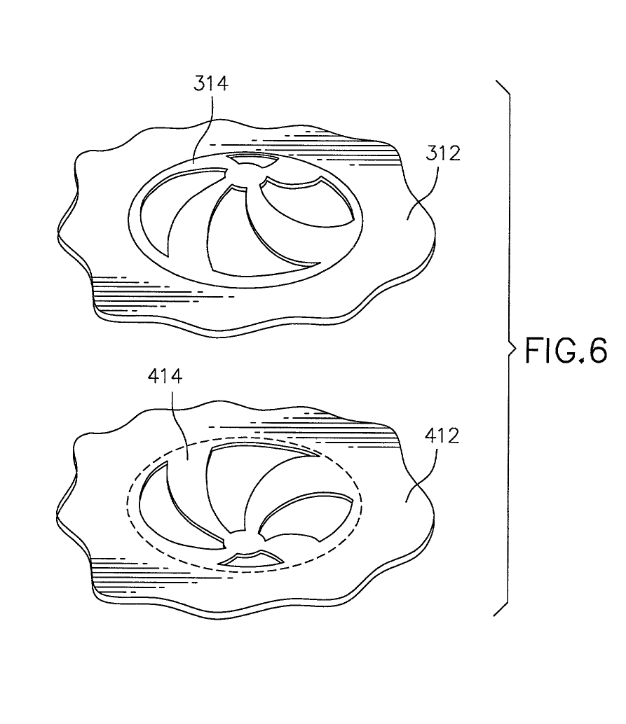

Referring now to FIG. 6, such microspring 314 is coupled to a backing substrate 312, and may also be used in conjunction with an opposite facing microspring 414 which is similarly coupled to a backing substrate 412.

It is to be understood that the exemplary nanolaminate structure described herein and shown in the drawings represents only a presently preferred embodiment of the invention. Indeed, various modifications and additions may be made to such embodiment without departing from the spirit and scope of the invention. For example, various different out-of-plane features of the mandrel and/or the nanolaminate structure are contemplated. As those skilled in the art will appreciate, such out-of-plane features may have various different geometrical configurations. Also, the mandrel need not be planar, but rather may define any desired shape or configuration. Thus, these and other modifications and additions may be obvious to those skilled in the art and may be implemented to adapt the present invention for use in a variety of different applications.

The scope of the invention is defined by the following claims.

What is claimed is:

1. A nanolaminate structure, comprising:
at least one layer of substantially a first metal, having an individual layer thickness of 1000 nanometers or less, adjacent at least one layer of substantially a second metal, having an individual layer thickness of 1000 nanometers or less;
such that the nanolaminate structure has at least one mechanical property with a desired value, which is improved over the same mechanical property of the first or second metal.

2. The nanolaminate structure of claim 1, wherein the first metal is copper.

3. The nanolaminate structure of claim 2, wherein the second metal is a nickel-copper alloy.

4. The nanolaminate structure of claim 3, wherein a yield strength of the nanolaminate is greater than either a yield strength of the copper or the nickel-copper alloy.

5. The nanolaminate structure of claim 3, wherein a hardness of the nanolaminate is greater than either a hardness of the copper or the nickel-copper alloy.

6. The nanolaminate structure of claim 3, wherein a ratio of the yield strength to the modulus of elasticity for the nanolaminate is greater than a ratio of the yield strength to the modulus of elasticity for either the copper or the nickel-copper alloy.

7. The nanolaminate structure of claim 1, wherein the metal layers alternate between the first metal and the second metal.

8. A nanolaminate structure, comprising:
a plurality of adjacent metal layers, each having a thickness less than 1000 nanometers, where the composition of the adjacent metal layers alternates between substantially a first metal and substantially a second metal;
wherein at least one mechanical property of the nanolaminate is improved over the same mechanical property of the first and second metal.

9. The nanolaminate structure of claim 8, wherein the first metal is copper and the second metal is nickel.

10. The nanolaminate structure of claim 8, wherein said structure comprises at least 100 alternating layers.

11. The nanolaminate structure of claim 8, wherein said structure comprises about 100 to 1000 alternating layers.

12. The nanolaminate structure of claim 8, wherein said structure comprises about 1000 to 10000 alternating layers.

13. A nanolaminate structure, comprising:
a plurality of adjacent metal layers, each having a thickness less than 1000 nanometers, where the composition of the adjacent metal layers alternates between a first metal and an alloy of the first metal and a second metal;
wherein at least one mechanical property of the nanolaminate is improved over the same mechanical property of the first and second metal.

14. The nanolaminate structure of claim 13, wherein the alloy is comprised of an alloy of nickel and copper.

15. The nanolaminate structure of claim 13, wherein said structure comprises at least 100 alternating layers.

16. The nanolaminate structure of claim 13, wherein said structure comprises about 100 to 1000 alternating layers.

17. The nanolaminate structure of claim 13, wherein said structure comprises about 1000 to 10000 alternating layers.

18. A nanolaminate structure, comprising a plurality of layers, including a base layer, a plurality of intermediate layers, and a surface layer, having:
a base layer comprising substantially a first metal;
a surface layer comprising either substantially the first metal or substantially a second metal;
a plurality of intermediate layers between the base and surface layers alternately comprising substantially the second metal, and substantially the first metal;
wherein at least one mechanical property of the nanolaminate structure is improved over the same mechanical property of the first metal or the second metal.

19. The nanolaminate structure of claim 18, wherein the structure comprises at least 100 intermediate layers.

20. The nanolaminate structure of claim 18, wherein the structure comprises about 100 to 1000 intermediate layers.

21. The nanolaminate structure of claim 18, wherein the structure comprises about 1000 to 10000 intermediate layers.

22. The nanolaminate structure of claim 18, wherein each layer is less than 1000 nanometers in thickness.

23. The nanolaminate structure of claim 18, further comprising a backing substrate adjacent the base layer.

24. The nanolaminate structure of claim 18, further comprising an out-of-plane feature defined by the layers.

25. A nanolaminate structure, comprising a plurality of layers, including a base layer, a plurality of intermediate layers, and a surface layer, having:
a base layer comprising substantially a first metal;
a surface layer comprising the first metal, or an alloy of the first metal and a second metal;
a plurality of intermediate layers between the base and surface layers alternately comprising an alloy of the first and second metals, and the first metal;
wherein at least one mechanical property of the nanolaminate structure is improved over the same mechanical property of the first metal, the second metal or the alloy.

26. The nanolaminate structure of claim 25, wherein the structure comprises at least 100 intermediate layers.

27. The nanolaminate structure of claim 25, wherein the structure comprises about 100 to 1000 intermediate layers.

28. The nanolaminate structure of claim 25, wherein the structure comprises about 1000 to 10000 intermediate layers.

29. The nanolaminate structure of claim 25, wherein each layer is less than 1000 nanometers in thickness.

30. The nanolaminate structure of claim 25, further comprising a backing substrate adjacent the base layer.

31. The nanolaminate structure of claim 25, further comprising an out-of-plane feature defined by the layers.

32. A nanolaminate structure formed according to a method comprising the steps of:
providing an electrolytic bath containing ions of a more noble metal and a less noble metal;
introducing a mandrel into the bath as a cathode;
controlling a plating current in the bath such that a current density at the cathode is maintained within a predefined range;
adjusting the plating current in the bath such that a layer comprising substantially the more noble metal is deposited on the mandrel;
adjusting the plating current in the bath such that a layer comprising substantially the less noble metal is deposited on the mandrel; and
removing the mandrel from the plating bath and separating the nanolaminate structure from the mandrel.

33. The nanolaminate structure of claim 32, wherein the plating current is adjusted a sufficient number of times to provide a nanolaminate structure with at least 100 total layers of the more noble metal and the less noble metal.

34. The nanolaminate structure of claim 32, wherein the plating current is adjusted a sufficient number of times to provide a nanolaminate structure with about 100 to 1000 total layers of the more noble metal and the less noble metal.

35. The nanolaminate structure of claim 32, wherein the plating current is adjusted a sufficient number of times to provide a nanolaminate structure with about 1000 to 10000 total layers of the more noble metal and the less noble metal.

36. The nanolaminate structure of claim 32, wherein the more noble metal is copper and the less noble metal is nickel.

37. A nanolaminate structure formed according to a method comprising the steps of:
providing an electrolytic bath containing ions of a more noble metal and a less noble metal;
introducing a mandrel into the bath as a cathode;
controlling a plating current in the bath such that a current density at the cathode is maintained within a predefined range;
adjusting the plating current in the bath such that a layer comprising substantially the more noble metal, and substantially none of the less noble metal, is deposited on the mandrel;
adjusting the plating current in the bath such that a layer comprising an alloy of the more noble and less noble metals is deposited on the mandrel; and
removing the mandrel from the plating bath and separating the nanolaminate structure from the mandrel.

38. The nanolaminate structure of claim 37, wherein the plating current is adjusted a sufficient number of times to provide a nanolaminate structure with at least 100 total layers of the more noble metal and the alloy of the more noble and less noble metals.

39. The nanolaminate structure of claim 37, wherein the plating current is adjusted a sufficient number of times to provide a nanolaminate structure with about 100 to 1000 total layers of the more noble metal and the alloy of the more noble and less noble metals.

40. The nanolaminate structure of claim 37, wherein the plating current is adjusted a sufficient number of times to provide a nanolaminate structure with about 1000 to 10000 total layers of the more noble metal and the alloy of the more noble and less noble metals.

41. The nanolaminate structure of claim 37, wherein the more noble metal is copper and the less noble metal is nickel.

42. The nanolaminate structure of claim 37, wherein the nanolaminate structure is applied to surface as a coating.

43. The nanolaminate structure of claim 37, wherein the nanolaminate structure is applied to an object to change a magnetic property of the object.

44. The nanolaminate structure of claim 1, wherein the nanolaminate structure comprises a plurality of microsprings.

45. The nanolaminate structure of claim 44, wherein the microsprings are electrically insulated from each other.

46. A nanolaminate structure formed according to a method comprising:
sputtering a layer comprising substantially a first metal onto a substrate;
sputtering a layer comprising substantially a second metal onto the layer of substantially the first metal;
sputtering a layer comprising substantially a first metal onto the layer of substantially the second metal;
wherein the thickness of each layer is less than 1000 nanometers; and
continuing the sputtering of alternating metal layers until the nanolaminate structure reaches a predefined thickness;
such that the nanolaminate structure has at least one mechanical property with a desired value, which is improved over the same mechanical property of the first or second metal.
